(19) United States
(12) Patent Application Publication
(10) Pub. No.: US 2003/0228802 A1
(43) Pub. Date: Dec. 11, 2003

(54) Filtered power connectors and methods thereof

(76) Inventors: Christopher P. Palagi, Upton, MA (US); Brian T. Trippe, Summerville, MA (US); Craig H. Baker, Shrewsbury, MA (US); Urs F. Nager, Hudson, NH (US)

Correspondence Address: Nixon Peabody LLP, Clinton Square, P.O. Box 31051, Rochester, NY, 14603-1051, US

(21) Appl. No.: 10/456,232

(22) Filed: Jun. 6, 2003

Related U.S. Application Data
(60) Provisional application No. 60/386,900, filed on Jun. 6, 2002.
(60) Provisional application No. 60/406,086, filed on Aug. 26, 2002.
(60) Provisional application No. 60/427,843, filed on Nov. 20, 2002.

(51) Int. Cl. H01R 13/66

(52) U.S. Cl. 439/620

(57) ABSTRACT

A filtered power connector includes a housing with at least one passage, at least one conductor, and at least one filter. The conductor extends at least partially into the passage in the housing and can handle currents greater than 40 amps. The filter has one end coupled to the conductor and another end coupled to a ground plane and filters out at a substantial portion of any signal between about 0 kHz and about 40 Ghz.

This application claims the benefit of U.S. Provisional Patent Application Serial No. 60/386,900 filed Jun. 6, 2002, U.S. Provisional Patent Application Serial No. 60/406,086 filed Aug. 26, 2002, and U.S. Provisional Patent Application Serial No. 60/427,843 filed Nov. 20, 2002 which are all herein incorporated by reference in their entirety.

### FIELD OF THE INVENTION

This invention relates generally to connectors and, more particularly to a compact, power connector that can filter and shield radiant EMI/RFI noise ingress or egress.

### BACKGROUND OF THE INVENTION

In certain areas of the world, consistent, high quality power is not the norm. Additionally, in other areas of the world, there may be occasional lapses in the delivery of high quality of power. When the quality of the power drops, the amount of fluctuation and noise, such as EMI noise and RFI noise, in the power often increases.

This lower quality power can cause problems. For example, this power can interfere with the proper performance of system which are receiving this power. Additionally, this lower quality power may damage any systems coupled to it.

### SUMMARY OF THE INVENTION

A filtered power connector in accordance with embodiments of the present invention includes a housing with at least one passage, at least one conductor, and at least one filter. The conductor extends at least partially into the passage in the housing and can handle currents greater than 40 amps. The filter has one end coupled to the conductor and another end coupled to a ground plane and filters out at a substantial portion of any signal on the conductor between about 0 kHz and about 40 Ghz.

A method for making a power connection system in accordance with embodiments of the present invention includes providing a housing with at least one passage. At least one conductor which can handle currents greater than 40 amps is extended at least partially into the passage in the housing. At least one filter that filters out a substantial portion of any signal between 0 kHz and 40 Ghz on the conductor is coupled at one end to the conductor and at another end to a ground plane.

The present invention provides a system and method which can simply and easily improve the quality of power being delivered. The present invention is able to filter the power to remove a substantial portion, if not all, of any signal between about 0 kHz and 40 GHz on the conductor.

Additionally, the present invention provides a system and method for monitoring and managing the delivery of power. For example, the present invention can be used to monitor and report on the quality of a power being delivered, to monitor and adjust the delivery of power to ensure that power requirements are being met, and can act as a safety shut off if a level of the power is too high or low.

### BRIEF DESCRIPTION OF THE DRAWINGS

FIG. 1A is a perspective view of a filtered power connector in accordance with embodiments of the present invention coupled to a pair of bus bars;

FIG. 1B is a perspective view of the filtered power connector shown FIG. 1A disconnected from the bus bars;

FIG. 2 is a cross-sectional, perspective view of a portion of the filtered power connector connected to one of the bus bars;

FIG. 3 is another cross-sectional view of the filtered power connector connected to the bus bars;

FIG. 4 is a perspective, end view of the filtered power connector;

FIG. 5 is an exploded, perspective view of the filtered power connector;

FIG. 6 is a partially broken away, perspective view of the filtered power connector coupled to the bus bars;

FIG. 7 is a perspective view of one end of a filtered power connector in accordance with other embodiments of the present invention;

FIG. 8 is a perspective view of another end of the filtered power connector shown in FIG. 7;

FIG. 9 is a perspective view of one end of the filtered power connector coupled to a pair of bus bars;

FIG. 10 is a partially broken away, perspective view of the filtered power connector coupled to the bus bars shown in FIG. 9; and

FIG. 11 is an exploded, perspective view of the filtered power connector and bus bars shown in FIG. 10.

FIG. 12 is a perspective view of one end of a filtered power connector with a female mate-side connector and a male power-side connector in accordance with other embodiments of the present invention;

FIG. 13 is a perspective view of one end of a filtered power connector with a male mate-side connector and a female power-side connector in accordance with other embodiments of the present invention;

FIG. 14 is a perspective view of one end of a filtered power connector with a female mate-side connector and a female power-side connector in accordance with other embodiments of the present invention;

FIG. 15A is a perspective view of one end of a filtered power connector with a common ground disconnected from a ground plane in accordance with other embodiments of the present invention;

FIG. 15B is a perspective view of one end of a filtered power connector with a common ground coupled to a ground plane in accordance with other embodiments of the present invention; as -may be employed to connect shielded power conductors;

FIG. 16 is a perspective view of one end of a filtered power connector with a male mate-side connector and a male power-side connector in accordance with other embodiments of the present invention;

FIG. 17 is an exploded view of the filter power connector shown in FIG. 16;

FIG. 18 is a perspective view of one end of a power supply connector with a female mate-side connector and a female power-side connector for coupling with the filtered power connector shown in FIGS. 16-17 in accordance with other embodiments of the present invention; and

FIG. 19 is an exploded view of the power supply connector shown in FIG. 18.

### DETAILED DESCRIPTION

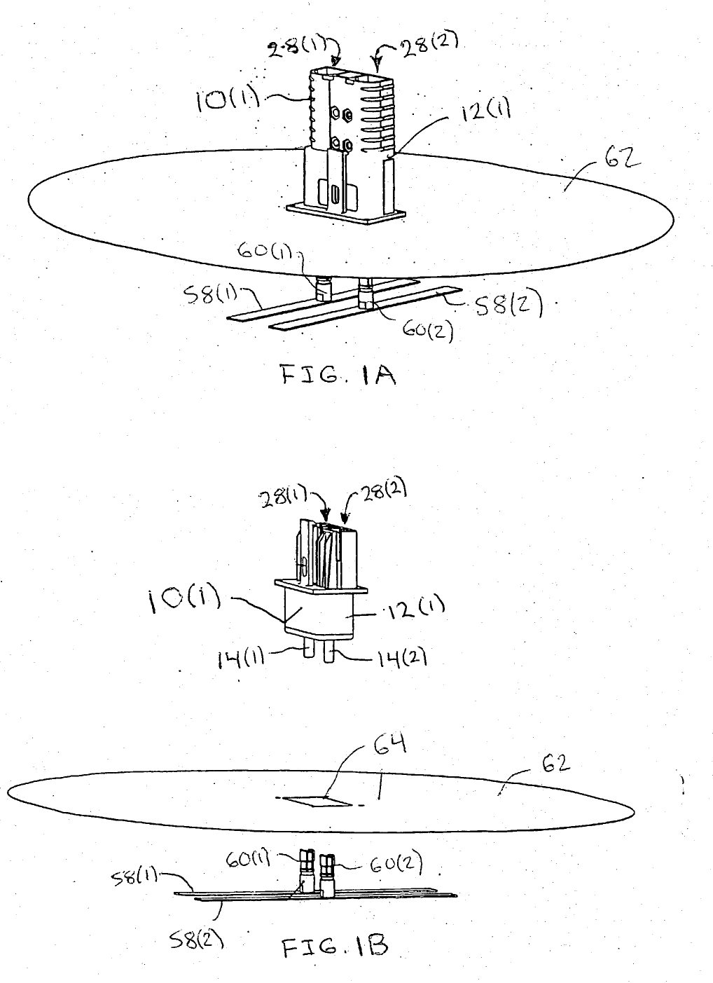

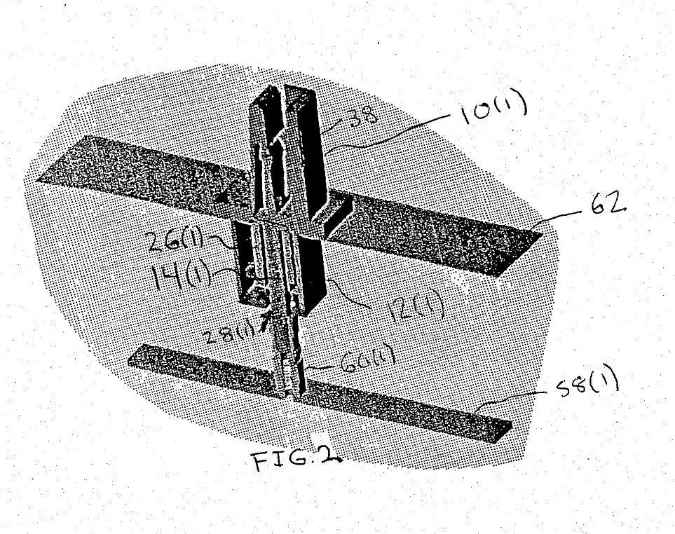

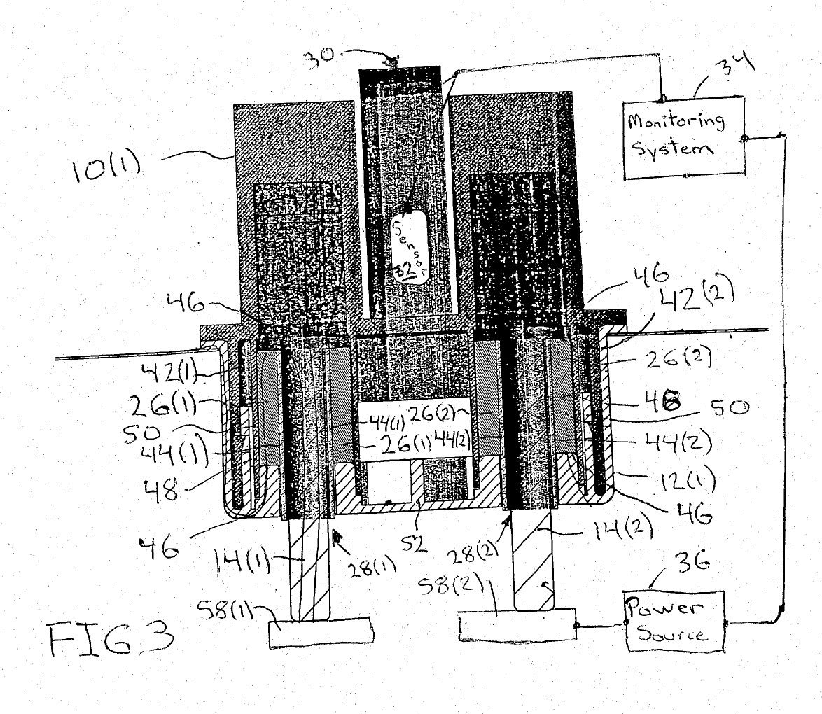

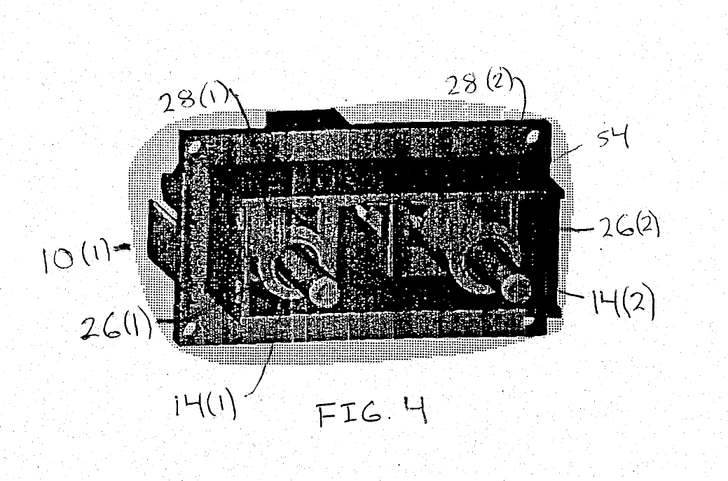

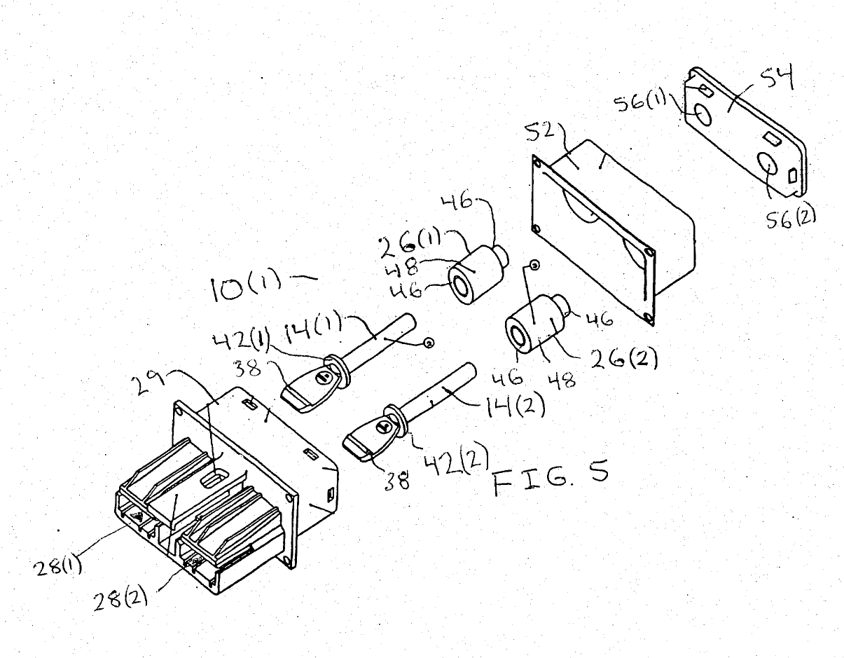

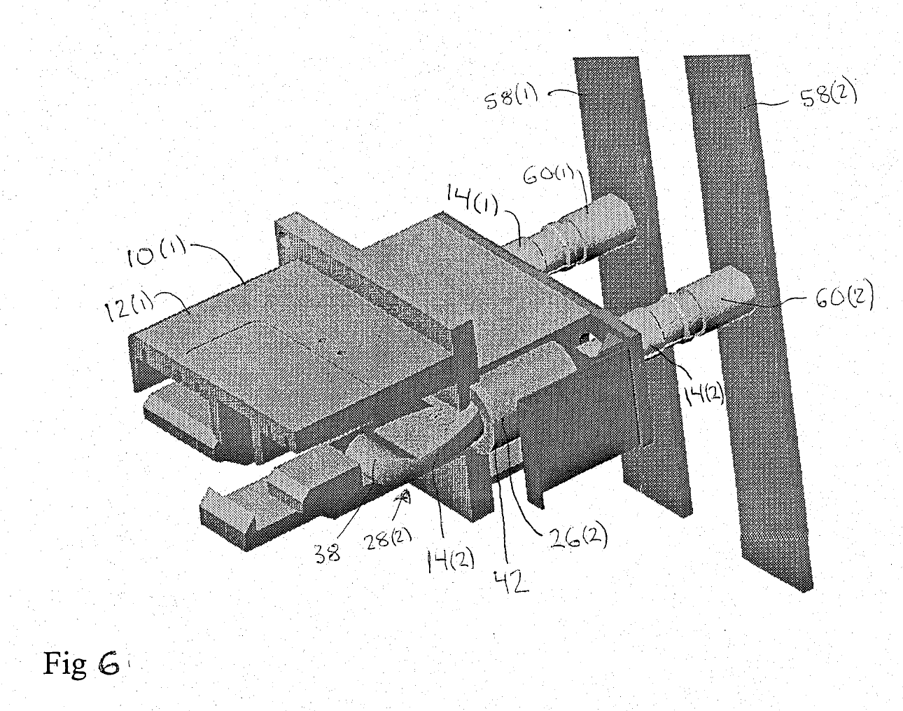

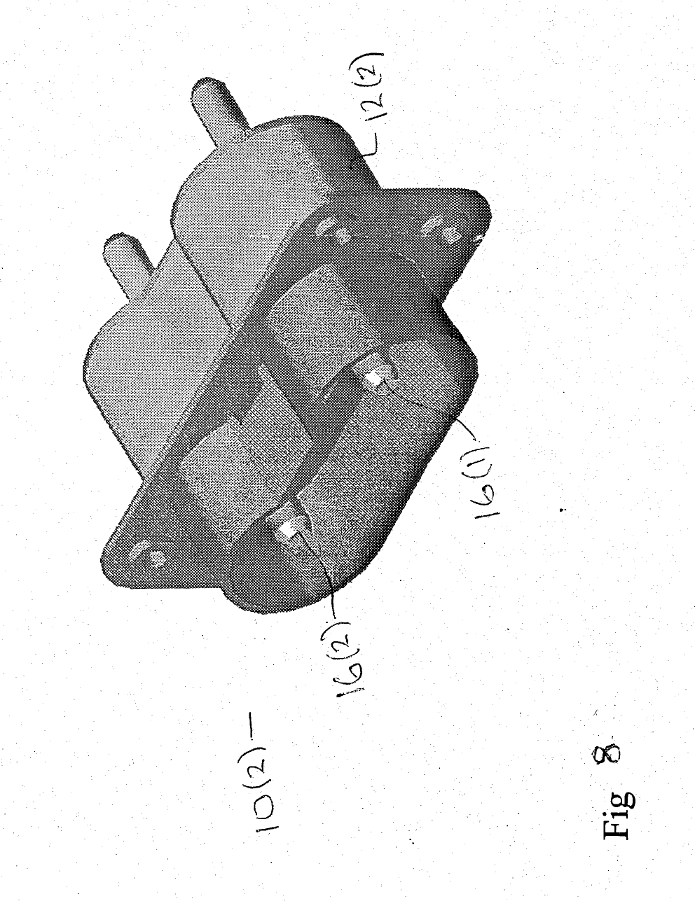

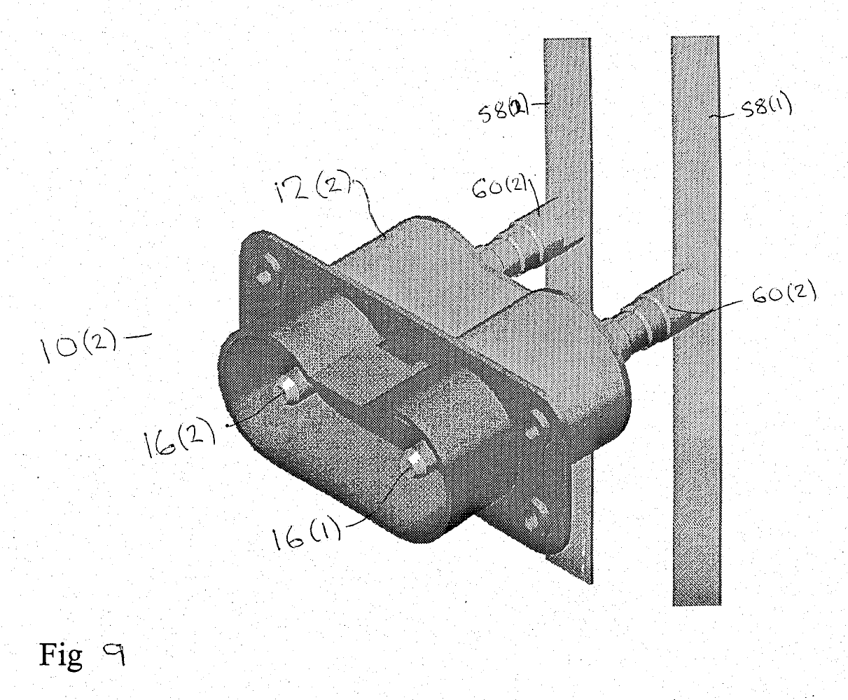

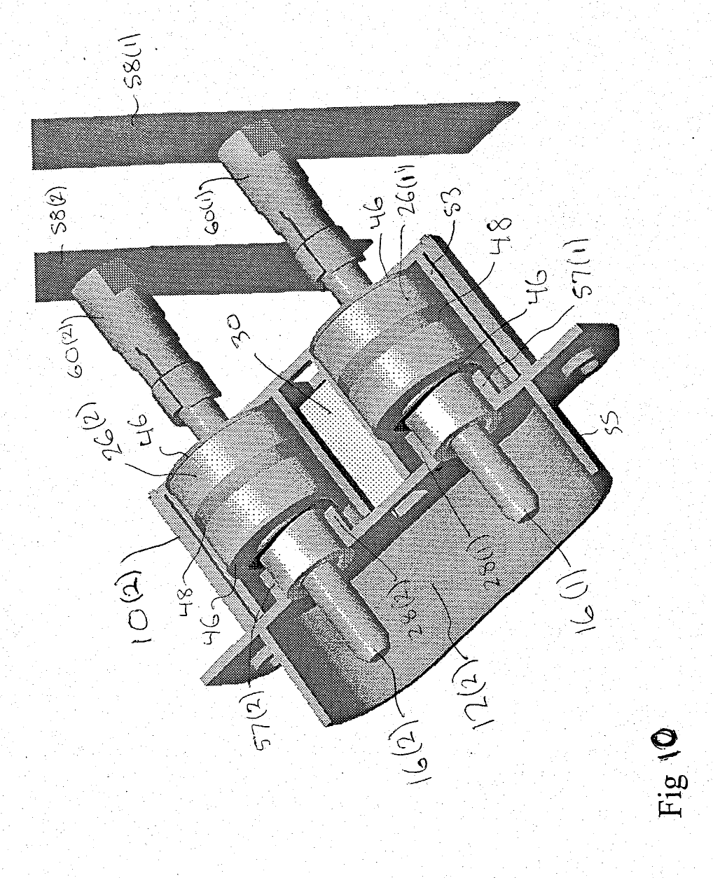

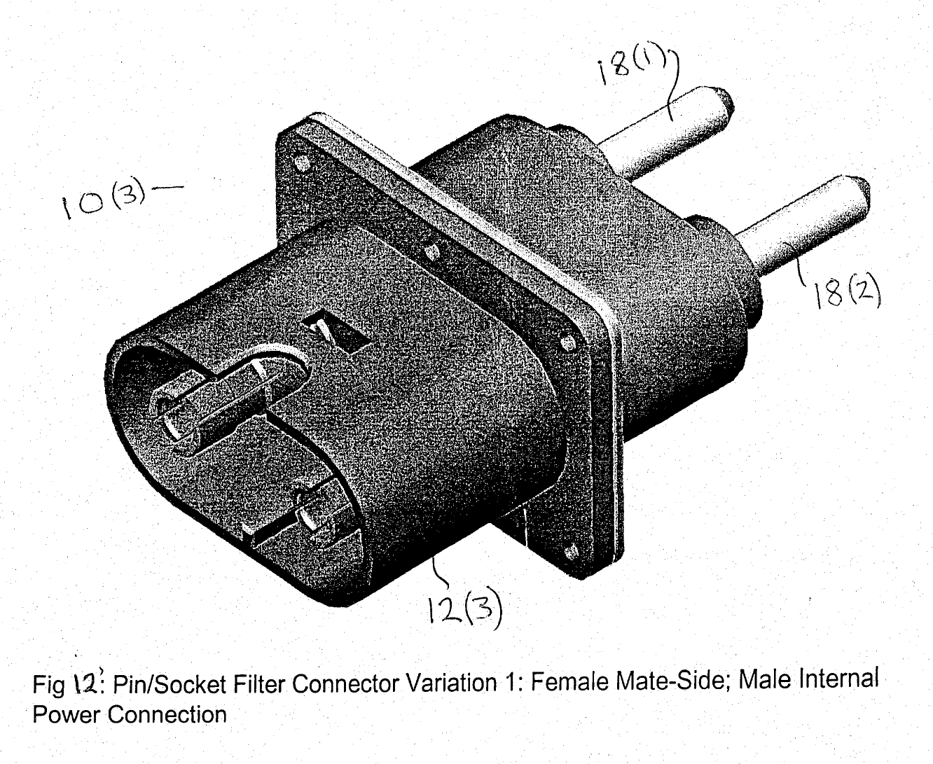

Filtered power connectors 10(1)-10(6) in accordance with embodiments of the present invention are illustrated in FIGS. 1-17. The filtered power connectors 10(1)-10(6) include a housing 12(1), 12(2), 12(3), 12(4) or 19, spindles or other conductors 14(1)-14(2), 16(1)-16(2), 18(1)-18(2), 20(1)-20(2), 22(1)-22(2), or 24(1)-24(2) and filters 26(1)-26(2), although the systems 10(1)-10(6) may each comprise other components, other numbers of the components, and other combinations of the components. The present invention provides a system and method which can simply and easily improve the quality of power being delivered and which also can monitor and manage the delivery of the power.

Referring to FIGS. 1-6, the housing 12(1) for the filtered power connector 10(1) includes a pair of passages 28(1)-28(2) and a chamber 30, although the housing 12(1) can have other configurations with other numbers of passages and chambers. Each of the passages 28(1)-28(2) is formed in the housing 12(1) to receive one of the spindles 14(1)-14(2) and one of the filters 26(1)-26(2), although the passages 28(1)-28(2) can have other configurations to accept other components. The chamber 30 is formed in the housing 12(1) between the passages 28(1)-28(2) to receive a sensor 32 which is used to monitor and manage the filtered power connector 10(1), although other numbers and locations for the chamber 30 in housing 12(1) could be used. The housing 12(1) is made from thermoplastic with a metalized finish on both sides that acts to shield EMI radiated RFI noise, although the housing 12(1) can be made of other materials. The housing 12(1) acts as a ground plane and a shielding cover, although any type of ground or earthing technique could be used.

The sensor 32 is a non-contact current sensor, although other types of circuitry could be used for sensor 32, such as programmed microprocessors, controllers, logic ICs, and various electrical, thermal or IR sensors. The sensor 32 is coupled to a monitoring system 34 that monitors readings from sensor 32 and which is coupled to and controls the operation of a power source 36 in response to the readings from sensor 32. For example, the monitoring system 36 may adjust the power being output or may shut the power off in response to a reading from the sensor 32. The monitoring system 34 comprises a processor and a memory which are coupled together by one or more buses, although monitoring system 34 can have other components, other numbers of the components, and other combinations of the components which are coupled together in other manners. In the monitoring system 34, the memory has stored programmed instructions for monitoring and managing the delivery of power as described herein for execution by the processor, although some or all of these instructions and data may be stored elsewhere. A variety of different types of memory storage devices, such as a random access memory (RAM), a read only memory (ROM) or a floppy disk, hard disk, CD ROM, or other computer readable medium which is read from and/or written to by a magnetic, optical, or other reading and/or writing system coupled to the processor, can be used. A variety of different types of wired and wireless communication systems and protocols can be used for the communications between the sensor 32, monitoring system 34, power source 36, and other components.

The spindles 14(1)-14(2) carry a power through the filtered power connector 10(1), although other types of conductors could be used to carry the power. In this particular embodiment, each of the spindles 14(1)-14(2) can handle currents over about 40 amps DC or AC up to about 1000 amps DC or AC, although the spindles 14(1)-14(2) can handle other amounts of current being supplied for power. Each of the spindles 14(1)-14(2) extends partially into and is seated in one of the passages 28(1)-28(2) in the housing 12(1), although other numbers and configurations for the spindles 14(1)-14(2) in the housing 12(1) could be used.

Each of the spindles 14(1)-14(2) includes a flange 42(1) or 42(2), although other types of and arrangements for the flanges 42(1)-42(2) can be used and the spindles 14(1)-14(2) may have other shapes. The flange 42(1) is formed on and is located between the ends of the spindle 14(1) and the flange 42(2) is formed on and is located between the ends of the spindle 14(2),

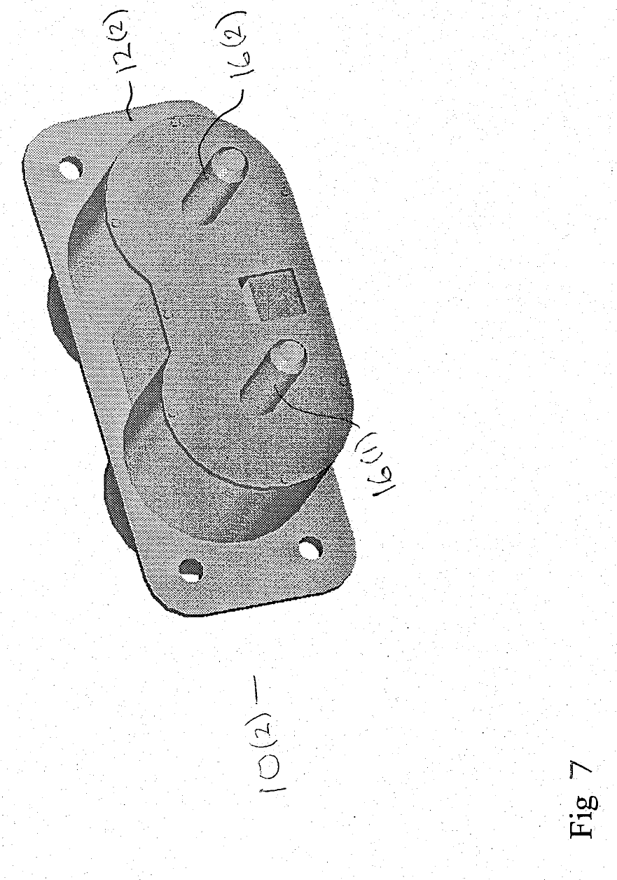

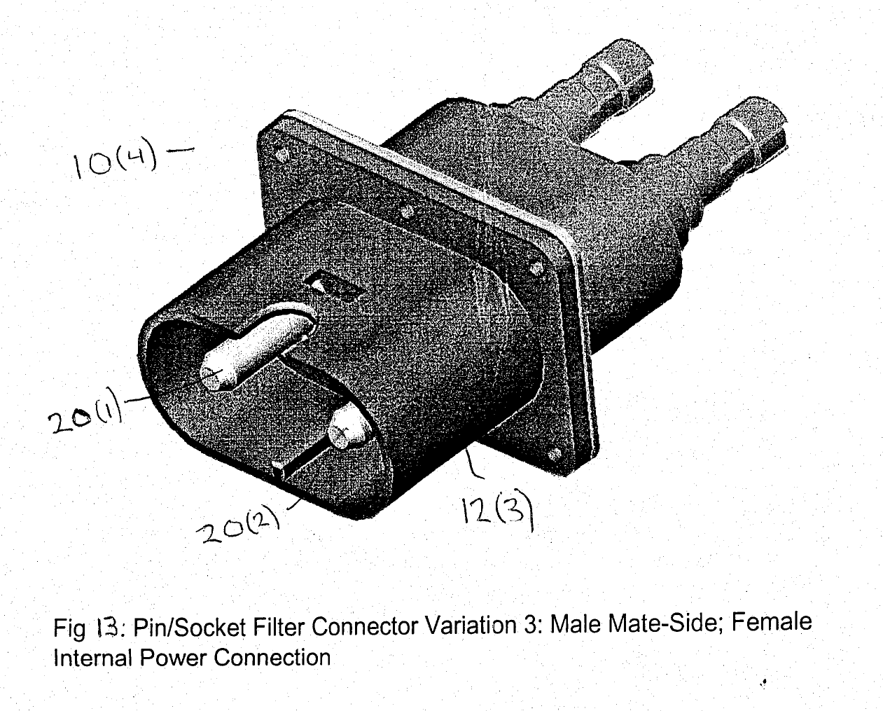

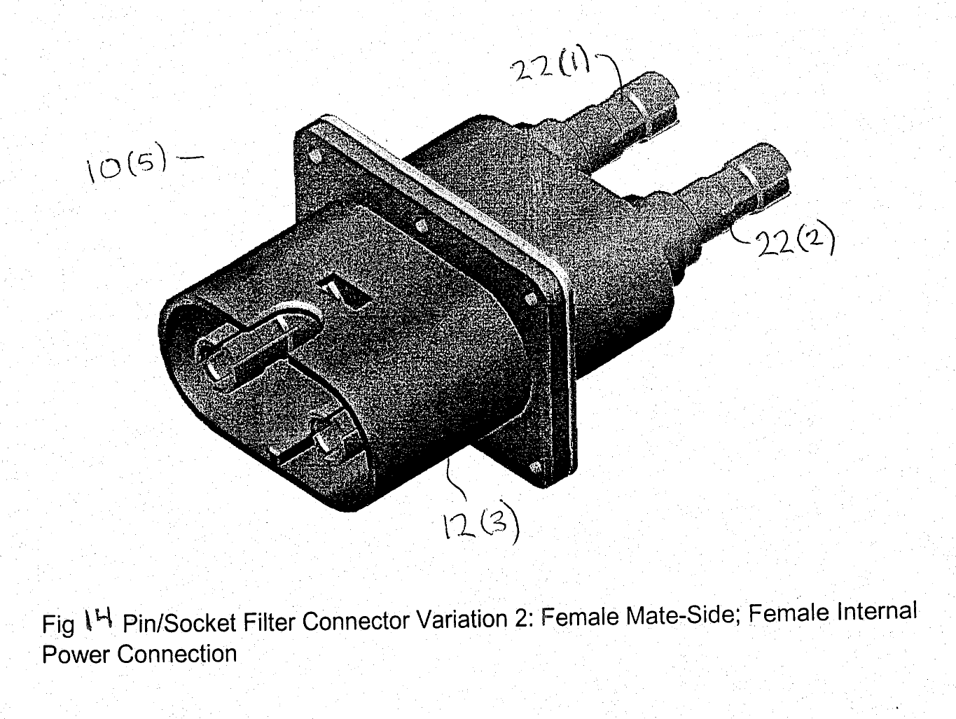

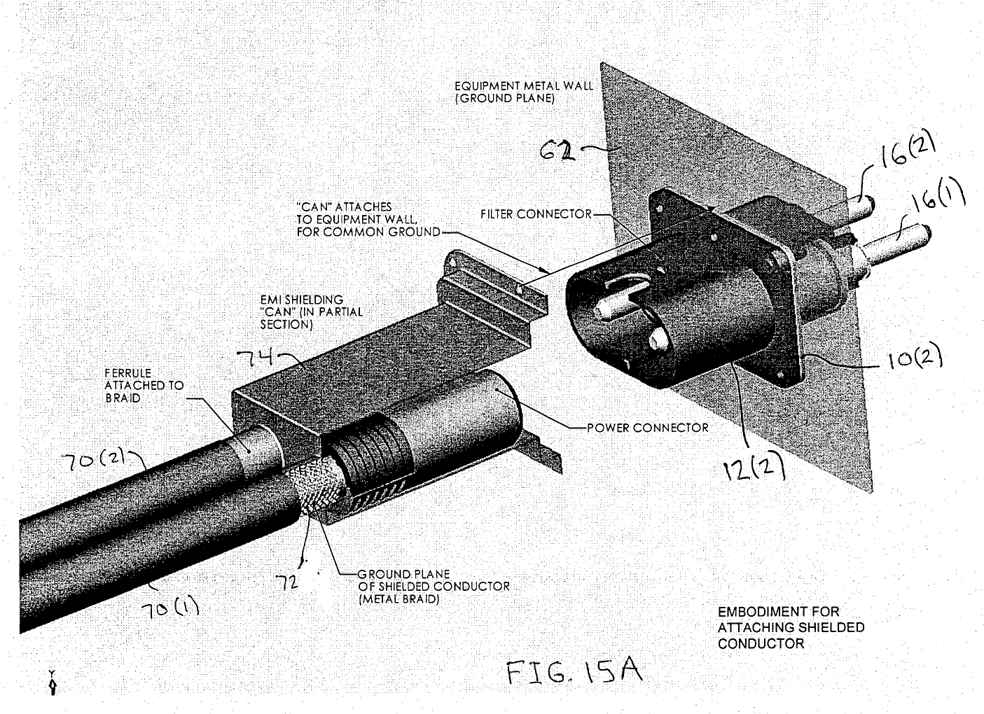

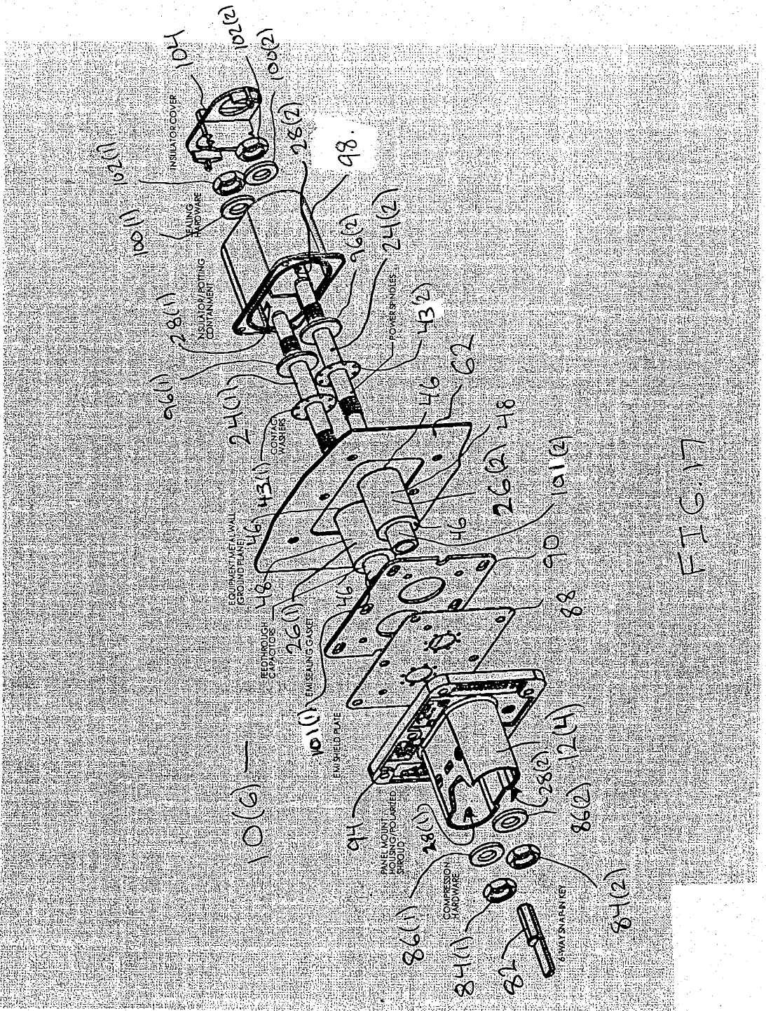

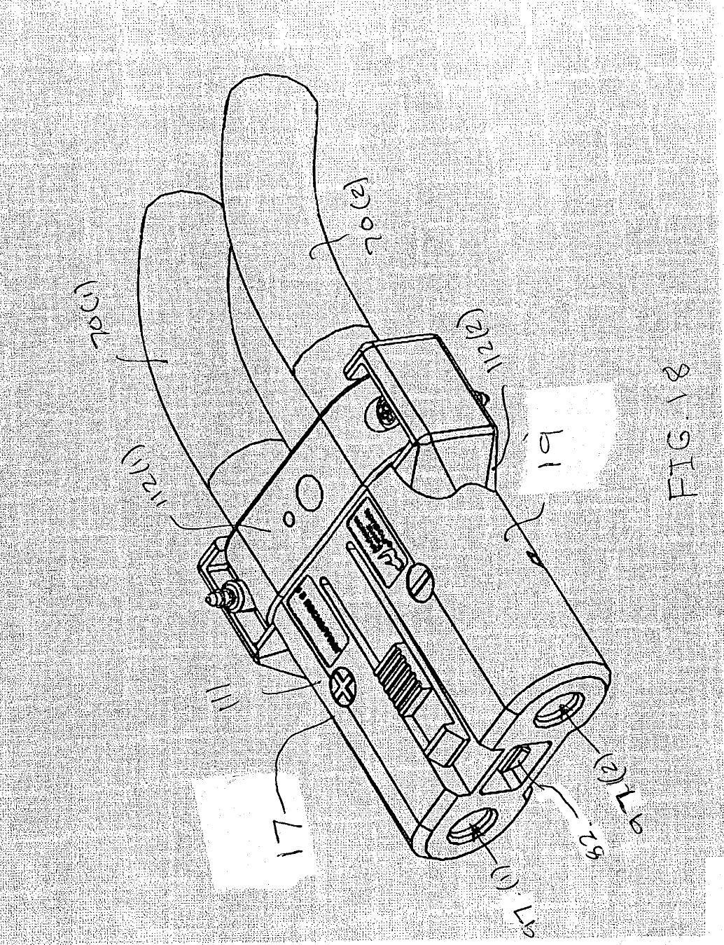

One end of each of the spindles 14(1)-14(2) has a cylindrical shape to form a male connector and the other end of each of the spindles 14(1)-14(2) has a flattened shape with a ridge 38 to form a genderless connector or contact, although the ends of the spindles 14(1)-14(2) can have other shapes and configurations and other mechanisms for coupling to each end of the spindles 14(1)-14(2) can be used. By way of example only, in the filtered power connector 10(2) shown in FIGS. 7-11 each of the spindles 16(1)-16(2) in the housing 12(2) has a cylindrical shape at each end to form a male connector at each end and in the filtered power connector 10(6) shown in FIGS. 16-17 each of the spindles 24(1)-24(2) in the housing 12(4) has a cylindrical shape at each end to form a male connector at each end. In the filtered power connector 10(3) shown in FIG. 12, each of the spindles 18(1)-18(2) in the housing 12(3) has a socket shape at one end to form a female connector and a cylindrical shape at the other end to form a male connector which is coupled to the power source. In the filtered power connector 10(4) shown in FIG. 13, each of the spindles 20(1)-20(2) in the housing 12(3) has a cylindrical shape at one end to form a male connector and a socket shape at the other end which is coupled to the power source to form a male connector. In the filtered power connector 10(5) shown in FIG. 14, each of the spindles 22(1)-22(2) in the housing 12(3) has a socket shape at each end to form a female connector at each end.

Referring back to FIGS. 1-6, filters 26(1) and 26(2) are used to filter the power on the spindles 14(1)-14(2) to produce clear, high quality output power. In this particular embodiment, the filters 26(1)-26(2) filter out a substantial portion of any signal between 0 kHz and 40 Ghz on the spindles 14(1)-14(2), although other types of filters in other ranges to filter power could be used.

Each of the filters 26(1)-26(2) is a capacitor with a substantially, tubular shaped, central dielectric region 48 between a pair of conductive regions 46, although the filters 26(1)-26(2) can have other shapes and configurations and other types of filters could be used. In this particular embodiment, the filter 26(1) is seated on and around a portion of the spindle 14(1) and the filter 26(2) is seated on and around a portion of the spindle 14(2), although other arrangements for the filters 26(1)-26(2) and spindles 14(1)-14(2) can be used. One of the conductive regions 46 for filter 26(1) is seated against the flange 42(1) and one of the conductive regions 46 for filter 26(2) is seated against the flange 42(2). An insulating layer 44(1) is located between and separates filter 26(1) from spindle 14(1) and an insulating layer 44(2) is located between and separates filter 26(1) from spindle 14(1), although other manners for insulating filters 26(1)-26(2) from spindles 14(1)-14(2) can be used. Each of the filters 26(1)-26(2) around the spindles 14(1)-14(2) is also seated in one of the passages 28(1)-28(2) in the housing 12(1).

An insulating cover 50 fits within one end of the housing 12(1) and serves to isolate the filters 26(1) and 26(2) from the metalized body of the housing 12(1). The insulating cover 50 provides a pair of openings 52 through which the one end of each of the spindles 14(1) and 14(2) can extend through.

A conductive cover 52 is secured to the housing 12(1) over the openings at one end of the passages 28(1)-28(2), although other arrangements for the cover 52 can be used. The cover 52 is in contact with and coupled to the other conductive region of filter 26(1) and the other conductive region of filter 26(2) as well as to the housing 12(1) and provides a grounding path from the other conductive regions 46 of filters 26(1)-26(2) to the housing 12(1), although other grounding or earthing techniques can be used.

An end cap 54 with passages 56(1)-56(2) is secured to one end of the conductive cover 52 with one end of spindles 14(1)-14(2) extending out through passages 56(1)-56(2), although other arrangements for housing the components could be used.

Bus bars 58(1)-58(2) are coupled between a power source 36 and one end of spindles 14(1)-14(2), although other numbers of bus bars and other manners of coupling power source 36 to spindles 14(1)-14(2) can be used. Each of the bus bars 58(1)-58(2) can carry currents for power applications. In this particular embodiment, each of the bus bars 58(1)-58(2) carries over about 40 amps up to about 1000 amps, although bus bars 58(1)-58(2) can carry other amounts of current. For ease of illustration, only a portion of each of the bus bars 58(1)-58(2) is shown.

A socket connector 60(1) is secured to bus bar 58(1) and a socket connector 60(2) is secured to bus bar 58(2), although other types of connectors 58(1)-58(2). One end of spindles 14(1)-14(2) mate in socket connectors 60(1)-60(2) to couple power on bus bars 58(1)-58(2) to spindles 14(1)-14(2), although other techniques for connecting the spindles 14(1)-14(2) to the bus bars 58(1)-58(2) can be used, for example male connectors could be used to couple to one end of spindles 14(1)-14(2) if the connectors at the one end of spindles 14(1)-14(2) are female connectors.

A chassis 62 acts as a ground plane, although other types of structures and other grounding or earthing techniques can be used. The chassis 62 has an opening 64 in which a portion of the housing 12(1) fits in and a flange of the housing 12(1) is secured and coupled to the chassis 62.

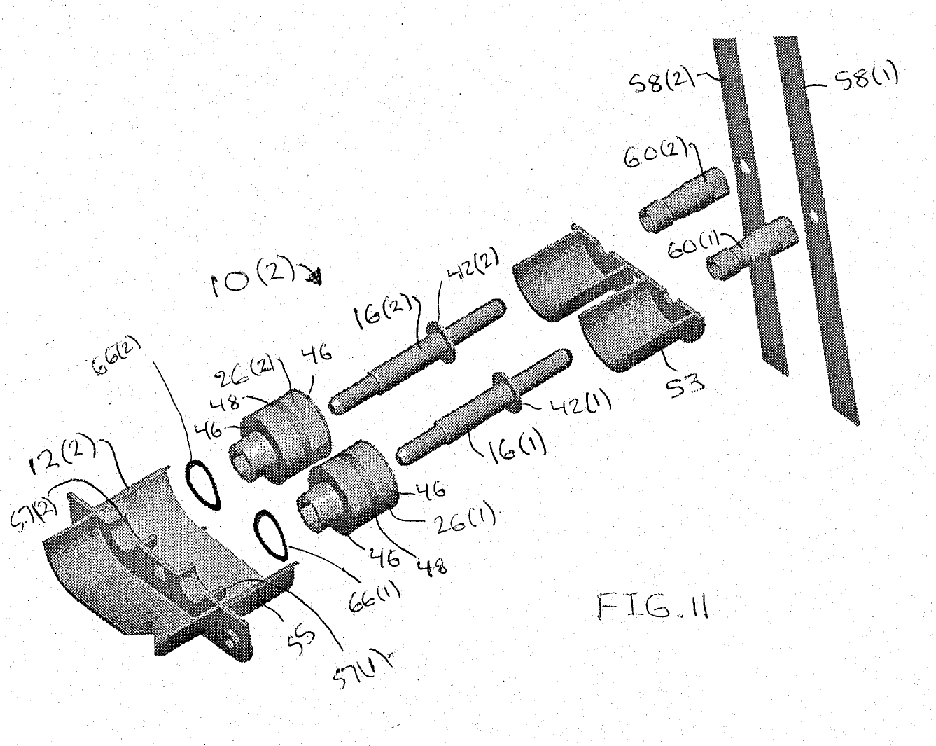

Referring to FIGS. 7-11, a filtered power connector 10(2) in accordance with other embodiments of the present invention is illustrated. Filtered power connector 10(2) is identical to filtered power connector 10(1), except as described and illustrated herein. Elements in filtered power connector 10(2) which are like those in filtered power connector 10(1) will have like reference numerals and will not be described again in detail. As discussed earlier, each of the spindles 16(1)-16(2) in the housing 12(2) has a cylindrical shape at each end to form a male connector at each end, although other types and numbers of conductors with other shapes can be used for spindles 16(1)-16(2) and the housing 12(2) is shaped to accommodate spindles 16(1)-16(2). Additionally, conductive washers 66(1)-66(2) are each seated on one of the filters 26(1)-26(2) and couple a conductive region 46 at one end of each of the filters 26(1)-26(2) the metallized body of the housing 12(2). An insulated housing 53 is formed to have passages for the spindles 16(1)-16(2) and for filters 26(1)-26(2) and the insulated housing 53 is seated in the conductive panel housing 55 as shown in FIG. 10. The conductive panel housing 53 includes conductive tubular projections 57(1)-57(2) which engage with and are coupled to the conductive washers 66(1)-66(2) and the other conductive regions 46 of filters 26(1)-26(2).

Referring to FIGS. 12-14, filtered power connectors 10(3)-10(5) in accordance with other embodiments of the present invention are illustrated. Filtered power connectors 10(3)-10(5) are identical to filtered power connector 10(1), except as described and illustrated herein. Elements in filtered power connector 10(3)-10(5) which are like those in filtered power connector 10(1) will have like reference numerals and will not be described again in detail. In the filtered power connector 10(3) shown in FIG. 12, each of the spindles 18(1)-18(2) in the housing 12(3) has a socket shape at one end to form a female connector and a cylindrical shape at the other end which is coupled to the power source to form a male connector, although other types and numbers of conductors with other shapes can be used for spindles 18(1)-18(2). The housing 12(3) is also shaped to accommodate spindles 18(1)-18(2). In the filtered power connector 10(4) shown in FIG. 13, each of the spindles 20(1)-20(2) in the housing 12(3) has a cylindrical shape at one end to form a male connector and a socket shape at the other end which is coupled to the power source to form a male connector, although other types and numbers of conductors with other shapes can be used for spindles 20(1)-20(2). The housing 12(4) is also shaped to accommodate spindles 20(1)-20(2). In the filtered power connector 10(5) shown in FIG. 14, each of the spindles 22(1)-22(2) in the housing 12(3) has a socket shape at each end to form a female connector at each end, although other types and numbers of conductors with other shapes can be used for spindles 22(1)-22(2). The housing 12(4) is also shaped to accommodate spindles 22(1)-22(2).

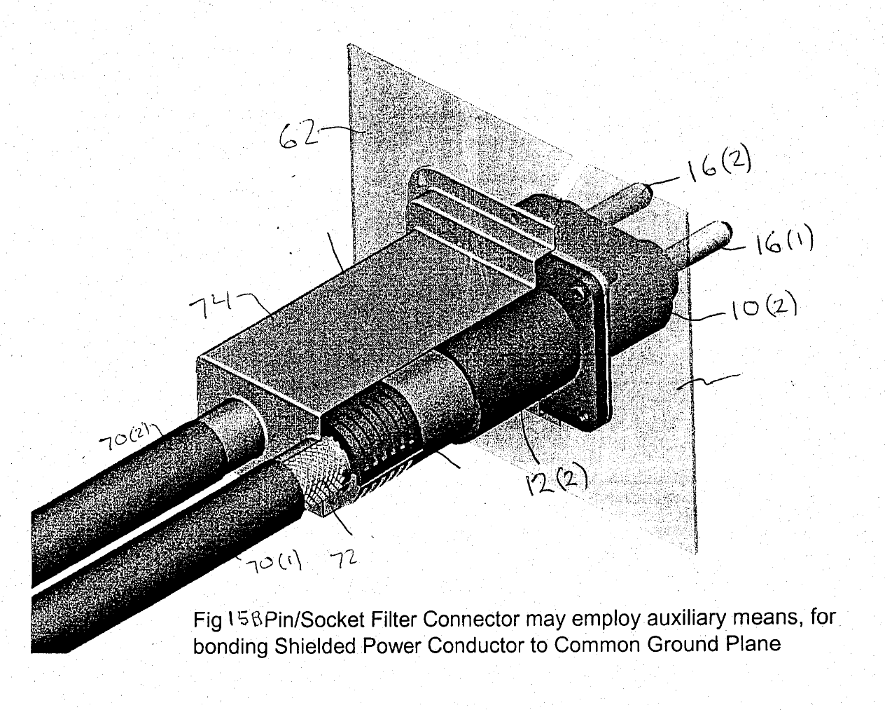

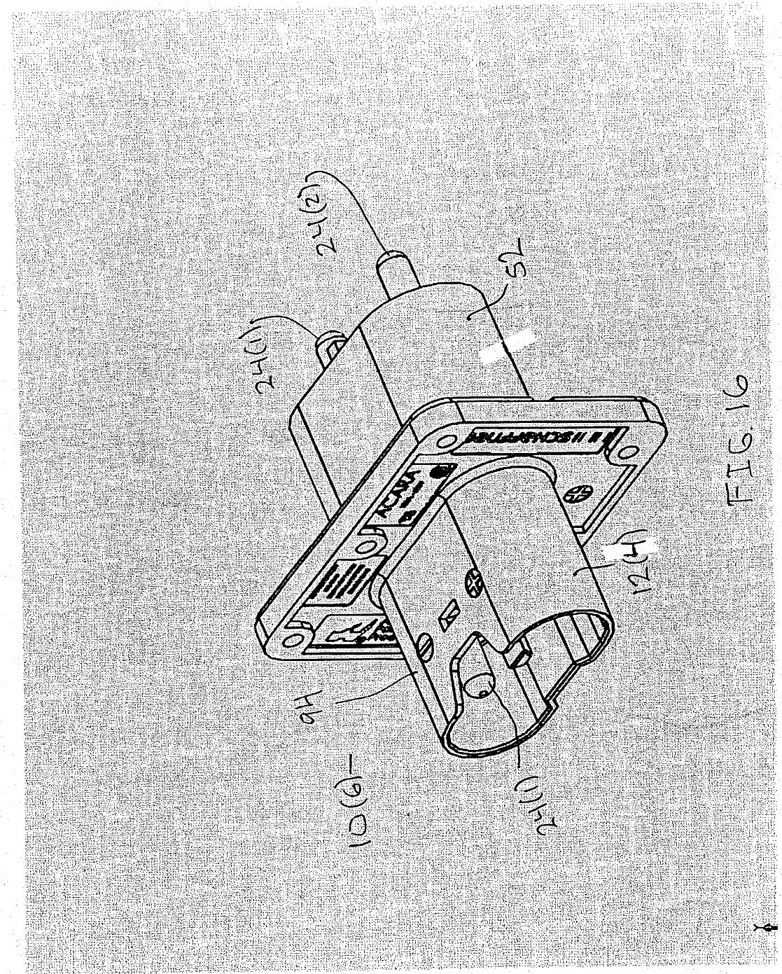

Referring to FIGS. 15A-15B, a filtered power connector 10(2) for coupling to power cables 70(1)-70(2) is illustrated. Power cables 70(1)-70(2) are coupled to a power source (nor shown) and each include a metal braid which acts as a cable ground 72. A conductive can housing is coupled to the cable ground 72 for each power cable 70(1)-70(2) and is coupled to the chassis 62. Coupling the cable ground 72 for each power cable 70(1)-70(2) to the chassis 62 forms a common ground with the other conductive region 46 of filters 26(1)-26(2) which are also coupled to the chassis 62, although other manners for forming a common ground can be used with this power connector 10(2) and with other power connectors.

Referring to FIGS. 16 and 17, a filtered power connector 10(6) in accordance with other embodiments of the present invention is illustrated is illustrated. Filtered power connector 10(6) is identical to the filtered power connector 10(2) shown in FIGS. 7-11, except as described and illustrated herein. Elements in filtered power connector 10(6) which are like those in filtered power connector 10(2) will have like reference numerals and will not be described again in detail. The filter power connector 10(6) includes spindles 24(1)-24(2) with male connectors at each end, although the ends of spindles 24(1)-24(2) can be configured to have other types of connectors, such as female or genderless connectors.

The filtered power connector 10(6) also includes filters 26(1)-26(2). The filter 26(1) is seated on the spindle 24(1) with one of the conductive regions 46 of filter 26(1) seated against and coupled to the conductive washer 43(1) of spindle 24(1). The filter 26(2) is seated on the spindle 24(2) with one of the conductive regions 46 of filter 26(2) seated against and coupled to the conductive washer 43(2) of spindle 24(2). The conductive regions 46 for the filters 26(1)-26(2) which are coupled to the panel mount housing 94 are insulated from the spindles 24(1)-24(2) by insulating layers 101(1)-101(2). The conductive washer 43(1) is seated against flange 96(1) and the conductive washer 43(2) is seated against flange 96(2).

The filtered power connector 10(6) also includes an EMI shield plate 88 and an EMI sealing gasket 90 which are located between the panel mount housing 94 and the cover 98. The EMI shield plate 88 and the EMI sealing gasket 90 help to shield EMI from the filter power connector 10(6) and couple the conductive region 46 of the filters 26(1)-26(2) to the conductive panel mount housing 94 which is coupled to the chassis 62. The filters 26(1)-26(2) and one end of the spindles 24(1)-24(2) extend through openings in the EMI shield plate 88 and the EMI sealing gasket 90 into portions of the passages 28(1) and 28(2) in the panel mount 94 of housing 12(4), although other components and assembly configurations can be used.

A panel mount 94 forms part of the housing 12(4) and includes a portion of the passages 28(1)-28(2), although the panel mount 94 can include other numbers and types of passages and chambers. The panel mount 94 is made of an insulating material and is mounted to the chassis 62 which secures the EMI shield plate 88 and the EMI sealing gasket 90 between the panel mount 94 and the cover 98.

Nut 84(1) and washer 86(1) are used to secure the one end of the spindle 24(1) in the passage 28(1) in the panel mount 94. Nut 84(2) and washer 86(2) are used to secure the one end of the spindle 24(2) in the passage 28(2) in the panel mount 94. A six-way snap in key 82 is secured to the panel mount 94 between the passages 28(1)-28(2), although other types of keys could be used or the key could be left off. The snap-key 82 is used to help prevent the connection of another connector to the filtered power connector 10(6) with a mismatched voltage or current.

A cover 98 includes another portion of the passages 28(1)-28(2) for the other end of spindles 24(1)-24(2) and is also secured and to and compresses EMI gasket 90. Cover 98 is made of an insulating material and passes through and is not in contact with the chassis 62, although other arrangements can be used. Securing cover 98 to EMI gasket 90 puts flanges 96(1)-96(2) against the other conductive regions of filters 2691)-26(2) and allows the other end of spindles 24(1)-24(2) to pass through. Nut 102(1) and washer 100(1) are used to secured the other end of spindle 24(1) to the cover 98 and nut 102(2) and washer 100(2) are used to secured the other end of spindle 24(2) to the cover 98, although other arrangements for securing the components together can be used.

An insulator cover 104 is secured to the end of the cover 28. The insulator cover 104 provides openings for the other ends of the spindles 24(1)-24(2) to extend out to couple with a power source.

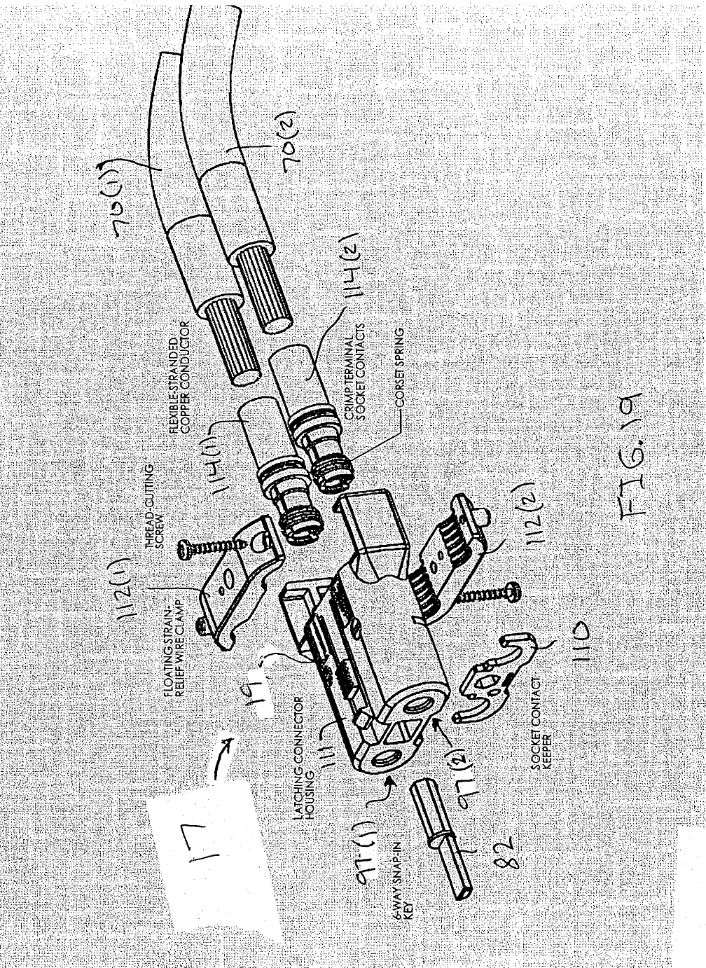

Referring to FIGS. 18 and 19, a power supply connector 17 for connecting with the filtered power connector 10(6) in accordance with other embodiments of the present invention is illustrated. The housing 19 for the power supply connector 17 has female connecting passages 97(1)-97(2) which house socket contacts 114(1)-114(2) for mating with the other end of spindles 24(1)-24(2), although other numbers and types of passages and connectors could be used, such as male connectors or genderless connectors.

The power supply connector 17 also has a six-way snap in key 82 which is secured in the housing 19 between the passages 97(1)-97(2), although other types of keys could be used or the key could be left off. The snap-key 82 is used to help prevent the connection of another connector to power supply connector 17 with a mismatched voltage or current.

The power supply connector 17 also has a socket contact keeper 110 which fits into a slot in the latching connector housing 11 and engages with and retains the socket contacts 114(1)-114(2) which have been inserted or mated with the passages 97(1)-97(2), although other types of retaining mechanisms could be used.

One end of each of the power cables 70(1)-70(2) is inserted and crimped into one end of the socket contacts 114(1)-114(2) and the other end of socket contacts 114(1)-114(2) are shaped to mate with the other end of spindles 24(1)-24(2), although again other types of connectors could be used for socket contacts 114(1)-114(2), such as male or genderless connectors. The clamps 112(1)-112(2) are secured around the cable insulation for power cables 70(1)-70(2) and a portion of the housing 19 and help to retain the socket contacts 114(1)-114(2) in place.

The method of making the filtered power connector 10(1) in accordance with embodiments of the present invention will now be described with reference to FIGS. 1-6. The filter 26(1) is slid on to the spindle 14(1) until one of the conductive regions 46 of the filter 26(1) is seated against and coupled to the flange 42(1) of spindle 14(1). The filter 26(2) is slid on to the spindle 14(2) until one of the conductive regions 46 of the filter 26(2) is seated against and coupled to the flange 42(2) of spindle 14(2). The spindle 14(1) with the filter 26(1) is seated in the passage 28(1) in housing 12(1) and the spindle 14(2) with the filter 26(2) is seated in the passage 28(2) in housing 12(1).

The conductive cover 52 has passages to allow the other ends of spindles 14(1)-14(2) to pass through and is seated over and is secured to panel mount housing 29. A cover 54 also has passages to allow the other ends of spindles 14(1)-14(2) to pass through and is secured to the end of cover 52. The filter power connector 10(1) is seated in an opening 64 in a chassis 62 with the cover 52 and panel mount housing 29 secured to the chassis 62. The other ends of the spindles 14(1)-14(2) are inserted in and coupled to the socket connectors 60(1)-60(2) which are coupled to bus bars 58(1)-58(2).

A sensor 32 may be inserted and secured in a chamber 30 in housing 12(1) and is coupled to a monitoring system 34. A variety of different wired and wireless communication systems and protocols may be used to couple sensor 32 to monitoring system 34. Monitoring system 34 is coupled to power source 36 and can be used to manage the operation of the power source 36 in response to readings from sensor 32. A conductive housing 74 or other conductive element can be used to couple the cable ground 72 for the power lines 70(1)-70(2) and the ground for the other conductive region 46 of filters 26(1)-26(2) to the chassis 62 to form a common ground as shown in FIGS. 15A-15B in this and in other embodiments.

The method of making the filtered power connector 10(2) in accordance with embodiments of the present invention will now be described with reference to FIGS. 7-11. The method of making the filtered power connector 10(2) is identical to the method of making filter power connector 10(1), except as described herein. The filter 26(1) is slid on to the spindle 16(1) until one of the conductive regions 46 of the filter 26(1) is seated against and coupled to the flange 42(1) of spindle 16(1). The filter 26(2) is slid on to the spindle 16(2) until one of the conductive regions 46 of the filter 26(2) is seated against and coupled to the flange 42(2) of spindle 16(2). A conductive washer 66(1) is slid on until the other one of the conductive region 46 of filter 26(1) is seated against and coupled to the washer 66(1). A conductive washer 66(2) is slid on until the other one of the conductive region 46 of filter 26(2) is seated against and coupled to the washer 66(2).

The spindle 16(1) with the filter 26(1) and conductive washer 66(1) are seated in the passage 28(1) in housing 12(2) and the spindle 15(2) with the filter 26(2) and conductive washer 66(1) are seated in the passage 28(2) in housing 12(2). When the spindles 16(1)-16(2), filters 26(1)-26(2) and conductive washers 66(1)-66(2) are seated in the passages 28(1)-28(2), the conductive tubular projections 57(1)-57(2) engage with and are coupled to the conductive washers 66(1)-66(2) and the other conductive regions 46 of filters 26(1)-26(2).

The insulated housing 53 which has passages for the spindles 16(1)-16(2) and for filters 26(1)-26(2) is seated in the conductive panel housing 55 to insulate and shield the filters 26(1)-26(2) from the conductive panel housing 55 as shown in FIG. 10. The other ends of the spindles 16(1)-16(2) extend through the openings in the insulated housing 53 and are inserted in and coupled to the sockets 60(1)-60(2) which are coupled to bus bars 58(1)-58(2).

The method of making the filtered power connectors 10(3)-10(5) in accordance with embodiments of the present invention will now be described with reference to FIGS. 12-14. The method of making the filtered power connectors 10(3)-10(5) is identical to the method of making filter power connector 10(2), except that the types of spindles 18(1)-18(2), 20(1)-20(2), and 22(1)-22(2) are different and couple to the bus bars 58(1)-58(2) or to other power lines differently based on the type of connector, e.g. male, female, or genderless, at the end of the spindles 18(1)-18(2), 20(1)-20(2), and 22(1)-22(2).

The method of making the filtered power connector 10(6) in accordance with embodiments of the present invention will now be described with reference to FIGS. 16-17. The method of making the filtered power connector 10(6) is identical to the method of making filter power connector 10(2), except as described herein.

Contact washers 42(1)-42(2) are each slid onto one of the spindles 24(1)-24(2) up to flanges 96(1)-96(2). Filters 26(1)-26(2) are each slid onto one of the spindles 24(1)-24(2) until one of the conductive regions 46 of each of the filters 26(1)-26(2) is seated against and coupled to the contact washers 43(1)-43(2). EMI gasket 90 is slid onto spindles 24(1)-24(2), sitting loosely in place momentarily. Shield plate 88 is slid onto spindles 24(1)-24(2) adjacent EMI gasket 90. Passages 28(1)-28(2) of panel-mount housing 94 are slid over one end of spindles 24(1)-24(2).

Nuts 84(1)-84(2) and washers 86(1)-86(2) are torqued onto the one end of the spindles 24(1)-24(2) in the passages 28(1)-28(2) to capture and compress contact washers 43(1)-43(2) and filters 26(1)-26(2) between flanges 96(1)-96(2) and shield plate 88. Insulating cover 98 is slid onto the other end of spindles 24(1)-24(2) and washers 100(1)-100(2) and nuts 102(1)-102(2) are torqued onto the other end of the spindles 24(1)-24(2) to capturing the cover 98 and the gasket 90 to the previously assembled components. This compresses the gasket 90 against the shield plate 88, and forms a liquid seal. Interior spaces within cover 98 are filled with potting compound. Insulator cover 104 is snapped into the rear of cover 98 (cosmetic purposes). Hex key 82 is snapped into desired orientation.

Finished filtered power connector 10(6) is now ready for installation to the chassis 62. Screws through the panel mount 94 fix the filtered power connector 10(6) and bear the gasket 90 against the chassis 62 completing the ground circuit. The insulating cover 98 projects with clearance through a cutout in the chassis 62, into the interior of the equipment.

The method of making the power supply connector 17 in accordance with embodiments of the present invention will now be described with reference to FIGS. 18-19. The socket contacts 114(1)-114(2) are crimped onto the ends of power cables 70(1)-70(2) and then are inserted in the passages 97(1)-97(2) in the housing 19. Socket contact keeper 110 is inserted in a slot in housing 19 to secure the socket contacts 114(1)-114(2) in place, although other types of retaining devices can be used. The clamps 112(1)-112(2) are secured around the socket contacts 114(1)-114(2) and a portion of the housing 19 and help to retain the socket contacts 114(1)-114(2) in place. The six-way key 82 is then inserted and locked in place in another passage between passages 97(1)-97(2). The finished power supply connector 17 is now ready to be coupled to filtered power connector 10(6), although power supply connector 17 can be configured in other manners to be able to mate with other filtered power supply connectors.

Although methods for making the filtered power connectors 10(1)-10(6) and a power supply connector 17 are described herein, other methods for making the filtered power connectors 10(1)-10(6) and a power supply connector 17 can also be used.

The operation of the filtered power connector 10(1) in accordance with embodiments of the present invention coupled to a monitoring system 34 and to a power source 36 will now be described with reference to FIGS. 1-6. Power from a power source is provided to one end of the spindles 14(1)-14(2) from the bus bars 58(1)-58(2) or other power signal lines coupled to the spindles 14(1)-14(2). The power passes through the spindles 14(1)-14(2) out to other conductors coupled to the other end of the spindles 14(1)-14(2).

The filters 26(1)-26(2) filter the power as the power passes through the spindles 14(1)-14(2). In this particular embodiment, the filters 26(1)-26(2) filter out a substantial portion of any signal on the conductor between about 0 kHz and about 40 Ghz, although the filters 26(1)-26(2) can be configured to filter power in other manners, such as filtering out noise or spikes in the power signal. The conductive region 46 at one end of the filters 26(1)-26(2) is coupled to one of the flanges 42(1)-42(2) and the conductive region at the other end of the filters 26(1)-26(2) is coupled to the conductive cover 52 which is coupled to the housing 29 which is coupled to the chassis 62 which acts as ground. As a result, a substantial portion of any signal on the spindles 14(1)-14(2) is captured by the filters 26(1)-26(2) and is dissipated to ground through the cover 52 and housing 29 to chassis 62. As a result, the present invention is able to provide a clear, high quality power signal.

The sensor 32 also monitors one or more characteristics about the delivery of the power, such as the temperature or the current reading in each spindle 14(1)-14(2). Based on the reading from the sensor 32, the monitoring system 34 controls the operation of the power source 36. By way of example only, if the sensor 32 reads a temperature above a stored threshold, the monitoring system 34 may signal the power source to shut down. The sensor 32 may also read a current level which is too high or low and the monitoring system 34 will control the operation of the power source 36 in response to this reading to either increase or decrease the current level to the appropriate amount.

The operation of the filtered power connector 10(2) in accordance with embodiments of the present invention will now be described with reference to FIGS. 1-6. The operation of the filtered power connector 10(2) is the same as the operation of the filter power connector 10(1) with the sensor 32 and monitoring system 34, except as described herein.

Power from a power source is provided to one end of the spindles 16(1)-16(2) from the bus bars 58(1)-58(2) or other power signal lines coupled to the spindles 16(1)-16(2). The power passes through the spindles 16(1)-16(2) out to other conductors coupled to the other end of the spindles 16(1)-16(2).

The filters 26(1)-26(2) filter the power signal as the power signal passes through the spindles 16(1)-16(2). In this particular embodiment, the filters 26(1)-26(2) filter out a substantial portion of any signal on the spindles 16(1)-16(2) between about 0 kHz and about 40 Ghz, although the filters 26(1)-26(2) can be configured to filter power signals in other manners, such as filtering out noise or spikes in the power signal. The conductive region 46 at one end of the filters 26(1)-26(2) is coupled to one of the flanges 42(1)-42(2) and the conductive region at the other end of the filters 26(1)-26(2) is coupled to conductive washers 66(1)-66(2) which are coupled to conductive tubular projections 57(1)-57(2) which are coupled to the housing 55 which as ground. As a result, a substantial portion of any signal on the spindles 16(1)-16(2) is captured by the filters 26(1)-26(2) and is dissipated to ground through the conductive washers 66(1)-66(2) and the conductive tubular projections 57(1)-57(2) to the housing 55. As a result, the present invention is able to provide clear, high quality power. Although not shown, the filter power connector 10(2) may have a sensor 32 and a monitoring system 34 which operates as described above with reference to FIGS. 1-6.

The operation of the filtered power connectors 10(3)-10(5) and 10(7) in accordance with embodiments of the present invention is the same as the operation of the filter power connector 10(2), except that different spindles and housings are used and thus will not be described again.

The operation of the filter power connector 10(6) in accordance with embodiments of the present invention is the same as the operation of the filter power connector 10(1), except as described herein. The power supply connector 17 is connected to the one end of filtered power connector 10(6) so that power from a power source is provided to one end of the spindles 24(1)-24(2) from the power cables 70(1)-70(2), although other manners for delivering the power could be used. The power passes through the spindles 24(1)-24(2) out to other conductors coupled to the other end of the spindles 24(1)-24(2).

The filters 26(1)-26(2) filter the power as the power passes through the spindles 24(1)-24(2). In this particular embodiment, the filters 26(1)-26(2) filter out a substantial portion of any signal on the spindles 24(1)-24(2) between about 0 kHz and about 40 Ghz, although the filters 26(1)-26(2) can be configured to filter power in other manners. The conductive region 46 at one end of the filters 26(1)-26(2) is coupled to one of the flanges 43(1)-43(2) and the conductive region at the other end of the filters 26(1)-26(2) is coupled to EMI sealing gasket 90 which is coupled to EMI shield plate 88 which is coupled to the housing 94 which is coupled to chassis 62 that acts as ground. As a result, a substantial portion of any signal on the spindles 24(1)-24(2) is captured by the filters 26(1)-26(2) and is dissipated to ground through the EMI sealing gasket 90, EMI shield plate 88, panel housing 94 to the chassis 62. As a result, the present invention is able to provide a clear, high quality power. Although not shown, the filter power connector 10(6) may have a sensor 32 and a monitoring system 34 which operates as described above with reference to FIGS. 1-6.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefor, is not intended to limit the claimed processes to any order except as may be specified in the claims. Accordingly, the invention is limited only by the following claims and equivalents thereto.

What is claimed is:

1. A power connection system comprising:
a housing with at least one passage;
at least one conductor extends at least partially into the passage in the housing and can handle currents greater than 40 amps; and
at least one filter that filters out at a substantial portion of any signal on the conductor between about 0 kHz and about 40 Ghz, the filter having one end coupled to the conductor and another end coupled to ground.

2. The system as set forth in claim 1 wherein the conductor has one of a male connector at each end of the conductor, a male connector at one end of the conductor and a female connector at another end of the conductor, a female connector at one end of the conductor and a male connector at another end of the conductor, and a female connector at each end of the conductor.

3. The system as set forth in claim 1 wherein the conductor has a genderless connector at at least one end of the conductor.

4. The system as set forth in claim 1 wherein the other end of the filter is coupled to the housing.

5. The system as set forth in claim 4 further comprising a cover connected to one end of the passage in the housing, the cover is coupled between the other end of the filter and the housing.

6. The system as set forth in claim 1 wherein the conductor has a flange which is coupled to the one end of the filter.

7. The system as set forth in claim 1 wherein the filter is a capacitor.

8. The system as set forth in claim 1 further comprising an insulating layer between the conductor and the filter, the filter extending at least partially around the conductor and having a conductive surface at each end of the filter.

9. The system as set forth in claim 1 further comprising:
a cable coupled to one end of the conductor, the cable having a cable ground; and
a grounding element coupling the cable ground to the ground to form a common ground.

10. The system as set forth in claim 1 further comprising a sensor in the housing, the sensor monitors and outputs at least one characteristic of the conductor for managing the operation of the conductor.

11. The system as set forth in claim 10 wherein the sensor is a non-contact sensor.

12. The system as set forth in claim 1 wherein the housing has another passage and the system further comprises:
another conductor that extends at least partially into the another passage in the housing and can handle currents greater than 40 amps; and
another filter that filters out a substantial portion of any signal on the another conductor between 0 kHz and 40 Ghz, the another filter having one end coupled to the another conductor and another end coupled to the ground.

13. The system as set forth in claim 12 wherein the another conductor has one of a male connector at each end of the another conductor, a male connector at one end of the another conductor and a female connector at another end of the another conductor, a female connector at one end of the another conductor and a male connector at another end of the another conductor, and a female connector at each end of the another conductor.

14. The system as set forth in claim 12 wherein the another conductor has a genderless connector at at least one end of the another conductor.

15. The system as set forth in claim 12 wherein the other end of the filter is coupled to the housing.

16. The system as set forth in claim 12 further comprising a cover coupled between the other end of the another filter and the housing.

17. The system as set forth in claim 12 wherein the another conductor has a flange which is coupled to the one end of the another filter.

18. The system as set forth in claim 12 wherein the another filter is a capacitor.

19. The system as set forth in claim 12 further comprising an insulating layer between the another conductor and the another filter, the another filter extending at least partially around the another conductor and having a conductive surface at each end of the another filter.

20. The system as set forth in claim 12 further comprising:
another cable coupled to one end of the another conductor, the another cable having another cable ground; and
a grounding element coupling the another cable ground to the ground to form a common ground.

21. A method for making a power connection system, the method comprising:
providing a housing with at least one passage;
extending at least one conductor at least partially into the passage in the housing, the conductor can handle currents greater than 40 amps; and
coupling one end of at least one filter to the conductor and another end of the filter to ground, the filter filters out a substantial portion of any signal on the conductor between 0 kHz and 40 Ghz.

22. The method as set forth in claim 21 wherein the conductor has one of a male connector at each end of the conductor, a male connector at one end of the conductor and a female connector at another end of the conductor, a female connector at one end of the conductor and a male connector at another end of the conductor, and a female connector at each end of the conductor.

23. The method as set forth in claim 21 wherein the conductor has a genderless connector at at least one end of the conductor.

24. The method as set forth in claim 21 wherein the other end of the filter is coupled to the housing.

25. The method as set forth in claim 24 further comprising coupling the other end of the filter to the housing with a cover.

26. The method as set forth in claim 21 further comprising coupling a flange on the conductor to the one end of the filter.

27. The method as set forth in claim 21 wherein the filter is a capacitor.

28. The method as set forth in claim 21 further comprising placing an insulating layer between the conductor and the filter, the filter extending at least partially around the conductor and having a conductive surface at each end of the filter.

29. The method as set forth in claim 21 further comprising:
coupling a cable to one end of the conductor, the cable having a cable ground; and
coupling a grounding element between the cable ground and the ground to form a common ground.

30. The method as set forth in claim 21 further comprising monitoring and outputting at least one characteristic of the conductor for managing the operation of the conductor with a sensor.

31. The method as set forth in claim 30 wherein the sensor is a non-contact sensor.

32. The method as set forth in claim 21 wherein the housing has another passage and the method further comprises:
extending another conductor at least partially into the another passage in the housing, the another conductor can handle currents greater than 40 amps; and
coupling one end of another filter to the another conductor and another end of the another filter to a ground plane, the another filter filters out a substantial portion of any signal on the another conductor between 0 kHz and 40 Ghz.

33. The method as set forth in claim 32 wherein the another conductor has one of a male connector at each end of the another conductor, a male connector at one end of the another conductor and a female connector at another end of the another conductor, a female connector at one end of the another conductor and a male connector at another end of the another conductor, and a female connector at each end of the another conductor.

34. The method as set forth in claim 32 wherein the another conductor has a genderless connector at at least one end of the another conductor.

35. The method as set forth in claim 32 wherein the other end of the another filter is coupled to the housing.

36. The method as set forth in claim 32 further comprising coupling the other end of the another filter to the housing with a cover.

37. The method as set forth in claim 32 further comprising coupling a flange on the another conductor to the one end of the another filter.

38. The method as set forth in claim 32 wherein the another filter is a capacitor.

39. The method as set forth in claim 32 further comprising placing another insulating layer between the another conductor and the another filter, the another filter extending at least partially around the another conductor and having a conductive surface at each end of the another filter.

40. The method as set forth in claim 32 further comprising:
coupling another cable to one end of the another conductor, the another cable having another cable ground; and
coupling a grounding element between the another cable ground and the ground to form a common ground.
